(19) United States
(12) Patent Application Publication
(10) Pub. No.: US 2020/0218035 A1
(43) Pub. Date: Jul. 9, 2020

(54) CAMERA LENS AND ELECTRONIC DEVICE HAVING CAMERA FUNCTION

(71) Applicant: AAC Technologies Pte. Ltd., Singapore City (SG)

(72) Inventor: Yuchan Gao, Shenzhen (CN)

(21) Appl. No.: 16/729,454

(22) Filed: Dec. 29, 2019

(30) Foreign Application Priority Data
Jan. 8, 2019 (CN) 201920033220.2

(51) Int. Cl. G02B 13/00; H04N 5/225; G02B 9/34

(52) U.S. Cl. CPC G02B 13/0015; H04N 5/2254; G02B 9/34; H04N 5/2257

(57) ABSTRACT

A camera lens is provided, including first and second lenses sequentially stacked along a direction from an image side to an object side. The first lens includes a first optical portion for imaging. An outer contour of the first lens and an outer contour of the second lens have a same shape that is square. The first optical portion of the first lens has a circular edge tangent to the square outer contour of the first lens. With the present disclosure, the first optical portion of the first lens is the largest optical portion among all lenses, and a non-optical portion of the first lens having the largest optical portion can be removed. In this way, a horizontal length and a vertical length of each lens can be reduced, and thus a horizontal length and a vertical length of an entire camera lens can be reduced.

### TECHNICAL FIELD

The present disclosure relates to the technical field of optical imaging, and in particular, to a camera lens and an electronic device having a camera function.

### BACKGROUND

In recent years, with development of mobile phone technologies and rise of electronic devices having camera functions, camera lenses have been widely used in various products. In order to meet a trend that the electronic device is getting smaller and smaller, the camera lens must also develop to have a miniaturized dimension.

The camera lens in an existing electronic device includes a lens barrel and a plurality of lenses disposed in the lens barrel along a direction from an object side to an image side. Both an outer contour of the camera lens and an outer contour of each lens in the camera lens have circular shapes, and an outer ring of the lens is a fixed part having no imaging function, thereby resulting in a large dimension. As a result, the camera lens also has a large dimension.

Therefore, it is necessary to study a camera lens with a new structure.

### SUMMARY

The present disclosure provides a lens and an electronic device having a camera function, aiming to solve a problem that a camera lens of an electronic device includes a lens of a large dimension.

In view of this, the present disclosure provides a camera lens, including a first lens and a second lens that are sequentially stacked along a direction from an image side to an object side. The first lens includes a first optical portion for imaging and a first fixing portion arranged at an outer periphery of the first optical portion, an outer contour of the first lens and an outer contour of the second lens have a same shape that is square, and the first optical portion of the first lens has a circular edge tangent to the square outer contour of the first lens.

In an embodiment, the second lens includes a second optical portion for imaging and a second fixing portion arranged at an outer periphery of the second optical portion; and four vertexes of the first fixing portion are adhered to four vertexes of the second fixing portion by an adhesive.

In an embodiment, a gap is formed at a position where no adhesive is provided between the first fixing portion and the second fixing portion.

In an embodiment, both the first fixing portion and the second fixing portion are coated or plated with a black matting layer.

In an embodiment, the camera lens further includes at least one third lens arranged at an object side or an image side of the second lens, and each of the at least one third lens has an outer contour in a same shape of the outer contour of the first lens.

In an embodiment, four lenses are provided.

The present disclosure further provides an electronic device having a camera function. The electrode device includes the camera lens described above.

In an embodiment, the electronic device having a camera function is a mobile phone or a camera.

According to the present disclosure, the outer contour of the first lens and the outer contour of the second lens have a same shape that is square, the first optical portion of the first lens has a circular edge tangent to the square outer contour of the first lens, the first optical portion of the first lens is the largest optical portion among all lenses, and a non-optical portion of the first lens having the largest optical portion can be removed. In this way, a horizontal length and a vertical length of each lens can be reduced, and thus a horizontal length and a vertical length of an entire camera lens can be reduced, thereby facilitating increasing a screen occupancy ratio of the camera lens in the electronic device having a camera function while reducing the dimension of the electronic device.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a front sectional view of a camera lens according to an embodiment of the present disclosure;

FIG. 2 is a top view of FIG. 1.

FIG. 3 is a sectional view of the camera lens in FIG. 1 after being rotated by 45 degrees;

FIG. 4 is a top view of FIG. 3; and

FIG. 5 is a bottom view of FIG. 3.

### REFERENCE NUMERALS

1 camera lens
10 first lens
11 first optical portion
12 first fixing portion
20 second lens
21 second optical portion
22 second fixing portion
30 third lens
31 third optical portion
32 third fixing portion
40 fourth lens
41 fourth optical portion
42 fourth fixing portion
50 adhesive.

### DESCRIPTION OF EMBODIMENTS

The present disclosure will be described in details in the following with reference to the accompany drawings.

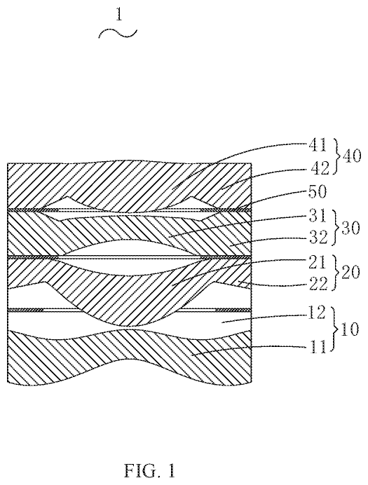

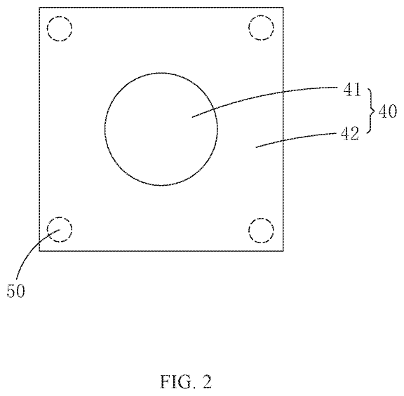

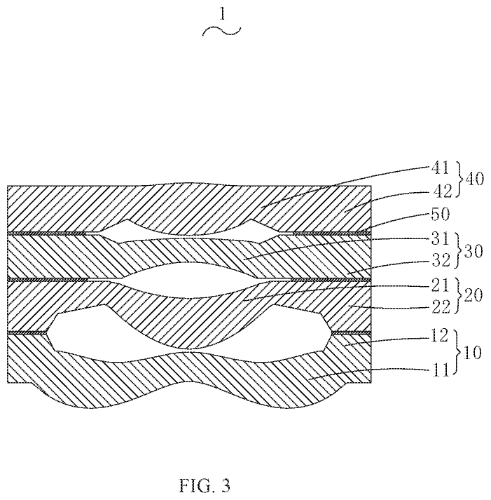

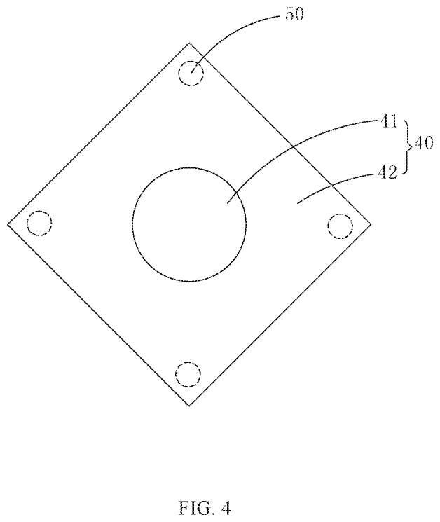

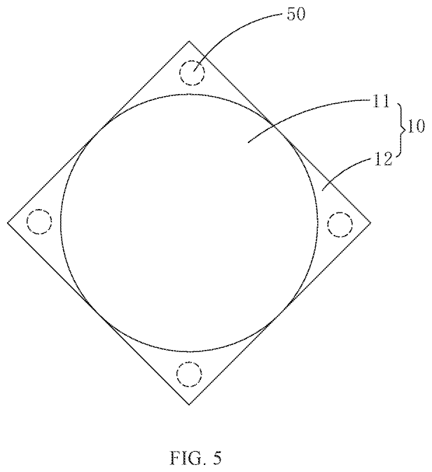

As shown in FIG. 1 to FIG. 5, the present disclosure provides a camera lens 1. The camera lens 1 includes a first lens 10 and a second lens 20 that are sequentially stacked along a direction from an image side to an object side.

Specifically, the first lens 10 includes a first optical portion 11 for imaging and a first fixing portion 12 arranged at an outer periphery of the first optical portion 11. The second lens 20 includes a second optical portion 21 for imaging and a second fixing portion 22 arranged at an outer periphery of the second optical portion 21. An outer contour of the first lens 10 and an outer contour of the second lens 20 have a same shape that is square. The first optical portion 11 of the first lens 10 has a circular edge tangent to the square outer contour of the first lens 10. The first optical portion 11 of the first lens 10 is the largest optical portion among all lenses. In the present disclosure, a non-optical portion of the first lens 10 having the largest optical portion can be removed. In this way, a horizontal length and a vertical length of each lens can be reduced, and thus a horizontal length and a vertical length of an entire camera lens 1 can be reduced, so that the camera lens 1 can meet the market requirements for miniaturization.

In an example, four vertexes of the first fixing portion 12 are respectively adhered and fixed to four vertexes of the second fixing portion 22 by an adhesive 50. A gap is formed at a position where no adhesive 50 is provided between the first fixing portion 12 and the second fixing portion 22. When the camera lens 1 is in an environment with high temperature or high humidity, gas between the first lens 10 and the second lens 20 will be heated to expand, and then the gas may flow out of the camera lens 1 via the gap between the first lens 10 and the second lens 20. This can avoid deformation of the lens and deteriorated optical performances of the camera lens 1 due to expansion of gas when being heated, thereby effectively improving reliability of the camera lens 1 applied in complex environments.

In an example, both the first fixing portion 12 and the second fixing portion 22 are coated or plated with a black matting layer. The black matting layer can effectively prevent generation of stray light, so that the camera lens 1 can have a better imaging effect. The black matting layer may be formed by being coated with ink or by blackening treatment.

In the present disclosure, the camera lens 1 further includes a third lens 30 and a fourth lens 40. Both the third lens 30 and the fourth lens 40 are arranged at an object side of the second lens 20, and the third lens 30 is arranged between the fourth lens 40 and the second lens 20. The third lens 30 includes a third optical portion 31 for imaging and a third fixing portion 32 arranged at an outer periphery of the third optical portion 31. The fourth lens 40 includes a fourth optical portion 41 for imaging and a fourth fixing portion 42 arranged at an outer periphery of the fourth optical portion 41. An outer contour of the third lens 30 and an outer contour of the fourth lens 40 have the same shape as the shape of the outer contour of the second lens 20. The first lens 10, the second lens 20, the third lens 30, and fourth lens 40 are sequentially stacked along the direction from the image side to the object side. Meanwhile, each lens is stacked in such a manner that an outer diameter of the optical portion gradually increases from the object side to the image side.

In an example, four vertexes at the top of the third fixing portion 32 are respectively adhered and fixed to four vertexes of the fourth fixing portion 42 by the adhesive 50, and four vertexes at the bottom of the third fixing portion 32 are respectively adhered to four vertexes of the second fixing portion 22 via the adhesive 50. A gap is also formed at a position where no adhesive 50 is provided between the second fixing portion 22 and the third fixing portion 32 and a position where no adhesive 50 is provided between the third fixing portion 32 and the fourth fixing portion 42. In this way, when the camera lens 1 is in an environment with high temperature or high humidity, gas can flow out of the camera lens 1 via the gap between respective lenses. This can avoid deformation of the lens and deteriorated optical performances of the camera lens 1 due to expansion of gas when being heated. Meanwhile, during use of camera lens 1, if water enters the camera lens 1, the water inside can be directly dried. In this way, water vapor will flow out of the camera lens 1 via the gap between adjacent lenses without affecting the performances of camera lens 1.

In an example, both the third fixing portion 32 and the fourth fixing portion 42 are coated or plated with a black matting layer for matting, so that the fixing portion of each lens of the entire camera lens 1 can be black, which can effectively avoid generation of stray light, so that the camera lens 1 can have a better imaging effect.

In the present disclosure, all lenses have a same side length, which is equal to an outer diameter of the first optical portion 11. In this embodiment, an effective portion of the first lens 10 except the first optical portion 11 can be removed, and the outer contour of each lens can be designed as a square shape. In this way, a horizontal length and a vertical length of each lens can be reduced, and thus a horizontal length and a vertical length of an entire camera lens 1 can be reduced, so that it is beneficial to increase a screen occupancy ratio of the camera lens 1 in the electronic device having a camera function and reduce the dimension of the electronic device.

Any two adjacent lenses are adhered to each other by the adhesive 50, that is, during an assembly process, the lenses are adhered to each other by the adhesive 50 without using the lens barrel. In this way, the camera lens 1 can have a reduced weight, thereby saving cost for manufacturing the camera lens 1. In this embodiment, the adhesive 50 is, for example, glue.

It should be noted that a number of the lenses is not limited to four as described above. For example, the number of the lenses may also be two (i.e., the camera lens 1 including only the first lens 10 and the second lens 20) or three (i.e., the camera lens 1 including the first lens 10, the second lens 20 and the third lens 30) or four or more, which depends on the actual needs.

In this embodiment, a method for manufacturing the camera lens 1 includes: directly injection-molding each lens; shearing or cutting it into a square shape; coating or plating a matting layer on each lens except an optical portion; and dispensing four vertexes of each square lens during assembly so as to assemble respective lenses into the camera lens 1.

An embodiment of the present disclosure further provides an electronic device having a camera function, which includes the camera lens 1 as described above. The electronic device having the camera function can be a mobile phone, a camera, or any other electronic device including the camera lens 1.

The above descriptions are merely embodiments of the present disclosure, and it should be noted that for those skilled in the art, improvements may be made without departing from an inventive concept of the present disclosure, however, all these are improvements shall be within the scope of the present disclosure.

What is claimed is:

1. A camera lens, comprising a first lens and a second lens that are sequentially stacked along a direction from an image side to an object side, wherein the first lens comprises a first optical portion for imaging and a first fixing portion arranged at an outer periphery of the first optical portion, an outer contour of the first lens and an outer contour of the second lens have a same shape that is square, and the first optical portion of the first lens has a circular edge tangent to the square outer contour of the first lens.

2. The camera lens as described in claim 1, wherein the second lens comprises a second optical portion for imaging and a second fixing portion arranged at an outer periphery of the second optical portion; and four vertexes of the first fixing portion are adhered to four vertexes of the second fixing portion by an adhesive.

3. The camera lens as described in claim 2, wherein a gap is formed at a position where no adhesive is provided between the first fixing portion and the second fixing portion.

4. The camera lens as described in claim 2, wherein both the first fixing portion and the second fixing portion are coated or plated with a black matting layer.

5. The camera lens as described in claim 1, further comprising at least one third lens arranged at an object side or an image side of the second lens, and each of the at least one third lens has an outer contour in a same shape of the outer contour of the first lens.

6. The camera lens as described in claim 2, further comprising at least one third lens arranged at an object side or an image side of the second lens, and each of the at least one third lens has an outer contour in a same shape of the outer contour of the first lens.

7. The camera lens as described in claim 3, further comprising at least one third lens arranged at an object side or an image side of the second lens, and each of the at least one third lens has an outer contour in a same shape of the outer contour of the first lens.

8. The camera lens as described in claim 4, further comprising at least one third lens arranged at an object side or an image side of the second lens, and each of the at least one third lens has an outer contour in a same shape of the outer contour of the first lens.

9. The camera lens as described in claim 1, wherein four lenses are provided.

10. The camera lens as described in claim 2, wherein four lenses are provided.

11. The camera lens as described in claim 3, wherein four lenses are provided.

12. The camera lens as described in claim 4, wherein four lenses are provided.

13. An electronic device having a camera function, comprising a camera lens, the camera lens comprising a first lens and a second lens that are sequentially stacked along a direction from an image side to an object side, wherein the first lens comprises a first optical portion for imaging and a first fixing portion arranged at an outer periphery of the first optical portion, an outer contour of the first lens and an outer contour of the second lens have a same shape that is square, and the first optical portion of the first lens has a circular edge tangent to the square outer contour of the first lens.

14. The electronic device having the camera function according to claim 13, wherein the electronic device having the camera function is a mobile phone or a camera.
